(19) United States
(12) Patent Application Publication
(10) Pub. No.: US 2002/0097919 A1
(43) Pub. Date: Jul. 25, 2002

(54) Method and apparatus for eliminating jagged effects using post filtering method

(76) Inventor: Chung-Yen Lu, Taipei (TW)

Correspondence Address: BIRCH STEWART KOLASCH & BIRCH, PO BOX 747, FALLS CHURCH, VA, 22040-0747, US

(21) Appl. No.: 09/783,091

(22) Filed: Feb. 15, 2001

(30) Foreign Application Priority Data
Dec. 6, 2000 (TW) 89126040

(51) Int. Cl. G06K 9/40; G06T 5/00

(52) U.S. Cl. 382/261; 382/269

(57) ABSTRACT

A post-filtering method is disclosed for eliminating jagged effects of computer graphic image before outputing graphic image in accordance with the characteristics of each of the pixels to determine if it needs to perform filtering to the pixel. The method includes the following steps: (a) judging if the pixel's Z-value is equal to zero, if it is, then not perform filtering to the pixel; (b) if the pixel's Z-value is not equal to zero, then judging if the pixel is located at the intersection of the Z-plane, if it is, then performs filtering to the pixel; (c) if the pixel is not located at the intersection of the Z-plane, then judging if the pixel is located at the constant-Z plane, if it is not, then not perform filtering to the pixel; and (d) if the pixel is located at the constant-Z plane, then judging if the pixel's color variation value is greater than the threshold value, if it is, then performs filtering to the pixel. Since the post filtering method for eliminating jagged effects of the invention performs filtering only to those pixels on the border of objects in the graphic image rather than to all the pixels of the graphic image. Therefore, the blurring effect can be avoided, and the perceptual quality of the graphic image can be satisfied.

### BACKGROUND OF THE INVENTION

1. Field of the Invention

The invention relates to a graphic filtering method, and more particularly, to a post filtering method by making use of the characteristics of pixel to judge if the pixel needs to be filtered for eliminating jagged effects of computer graphics.

2. Description of Related Art

In computer graphics, jagged silhouette edge is the most common manifestation of aliasing. And the so-called silhouette edge is the boundary of a polygon or any surface unit that exhibits a high contrast over its background.

Many popular filtering techniques, including the box filter, the triangle or tent filter, the Gaussian and similar shape filter, can be employed to eliminate the aliasing effect caused by jagged silhouette edges.

A digital filter can be a finite impulse response (FIR) or an infinite impulse response (IIR) filter. In general, a 2-D FIR filter is preferably employed in graphic images. The FIR filter is represented by an array of values. As shown in FIG. 1, the filter array 100 is positioned above the array of image values and the sum of products of the values in corresponding positions determines a single value taken at the center of the filter.

However, if one perform filtering to every pixel of a graphic image, the image will become blurring, and one may not satisfy its perceptual quality. Therefore, only those pixels on the silhouette edges are needed to perform filtering in order to eliminate the jagged effect and keep others from filtering so as to maintain the sharpness of the graphic image.

### SUMMARY OF THE INVENTION

In the light of the above-mentioned problems, it is an objective of the invention to provide a filtering method that makes use of the characteristic of the pixel to judge if the pixel needs to be filtered so as to eliminate jagged effect for obtaining better perceptual quality.

In accordance with the post filtering method of the invention for eliminating jagged effect, a pixel is to be determined if a filtering process needs to perform before outputing the image. The post filtering method includes the following steps:

Performing a Zero-Z test to test if a Z value of a pixel is equal to zero, if the Z-value of a pixel is equal to zero, then not perform a filtering, process to the pixel.

If the Z-value of a pixel is not equal to zero, then a judgement is made to see if the pixel is located at the intersection of a Z-plan, if the pixel is located at the intersection of the Z-plan, then performs the filtering process to the pixel.

If the pixel is not located at the intersection of the Z-plan, then a judgement is made to see if the pixel is located at a constant Z-plane, if the pixel is located at the constant Z-plane, then not perform the filtering process to the pixel.

If the pixel is located at the constant Z-plane, then a judgement is made to see if a color variation value is greater than a threshold value, if the color variation value is greater than a threshold value, then performs the filtering process to the pixel.

But the method does not perform filtering to all the pixels of the graphic image, rather, the method performs filtering only to those pixels on the border of the objects in the graphic image.

As the filtering method of the invention determines if the pixel needs to be filtered in accordance with the characteristic of the pixel, an image blurring can be prevented and a perceptual quality can be satisfied.

### BRIEF DESCRIPTION OF DRAWINGS

The objectives, characteristics, and advantages of the present invention can be more fully understood by reading the following detailed description of the preferred embodiment, with reference made to the accompanying drawings as follows:

FIG. 1 shows a schematic diagram of a pixel filtering of a digital filter according to a prior art.

FIG. 2 shows a flow chart of the post filtering method for eliminating the jagged effect of the first embodiment according to the invention.

FIG. 3 shows a flow chart of the post filtering method for eliminating the jagged effect of the second embodiment according to the invention.

FIG. 4 shows a flow chart of the post filtering method for eliminating the jagged effect of the third embodiment according to the invention.

FIG. 5 shows a flow chart of the post filtering method for eliminating the jagged effect of the fourth embodiment according to the invention.

### DETAILED DESCRIPTION OF PREFERRED EMBODIMENT

The post filtering method of the invention makes use of the characteristic of a pixel such as a Z-position, a Z-value and a color etc. to judge if the pixel needs to be filtered so as to eliminate jagged effect. But the method does not perform filtering to all the pixels of the graphic image, rather, the method performs filtering only to those pixels on the border of the objects in the graphic image. This is not only to improve the processing speed but also to prevent the images from blurring as well as to satisfy the perceptual quality of the graphic images.

The method for judging the characteristic of the pixels includes a Z-border test, a Zero-Z test, a Constant-Z test, and a Color-variation test With these tests, the graphic images will be adaptively filtered to obtain better perceptual quality.

The Z-border test is to test whether a pixel is located on the border of a triangle based on the Z values and the neighboring pixels. Table 1 and Fomulas (1)˜(4) illustrate an example of the Z-border test. The example is to judge if the pixel Z (1, 1) is located on the border of a triangle. If the relations shown in Fomulas (1)˜(4) are all true, then it indicates that the pixel Z (1, 1) is within the triangle. On the contrary, if any one of the Fomulas (1)˜(4) is not true, then pixel (1, 1) is within the border of the triangle. All of the Z the value shown in Fomulas (1)˜(4) are threshold values.

TABLE 1

| | | |
|---|---|---|
| Z (0, 0) | Z (0, 1) | Z (0, 2) |
| Z (1, 0) | Z (1, 1) | Z (1, 2) |
| Z (2, 0) | Z (2, 1) | Z (2, 2) |

Z(0,0)+Z(2,2)−2*Z(1,1)<Zth (1)

Z(0,1)+Z(2,1)−2*Z(1,1)<Zth (2)

Z(0,2)+Z(2,0)−2*Z(1,1)<Zth (3)

Z(1,0)+Z(1,2)−2*Z(1,1)<Zth (4)

Besides, the Zero-test is to test whether the Z value of a pixel is equal to zero. The Constant-Z test is to test whether the Z value of a pixel is similar to the Z values of its neighboring pixels. And the Color-variation test is to check whether thr color value of a pixel is similar to its neighboring pixels' colors. The judging method is to compare if the difference in color between a pixel and its surrounding pixels greater than a th threshold value C^{th} of color, if it is so, then the judgement is true.

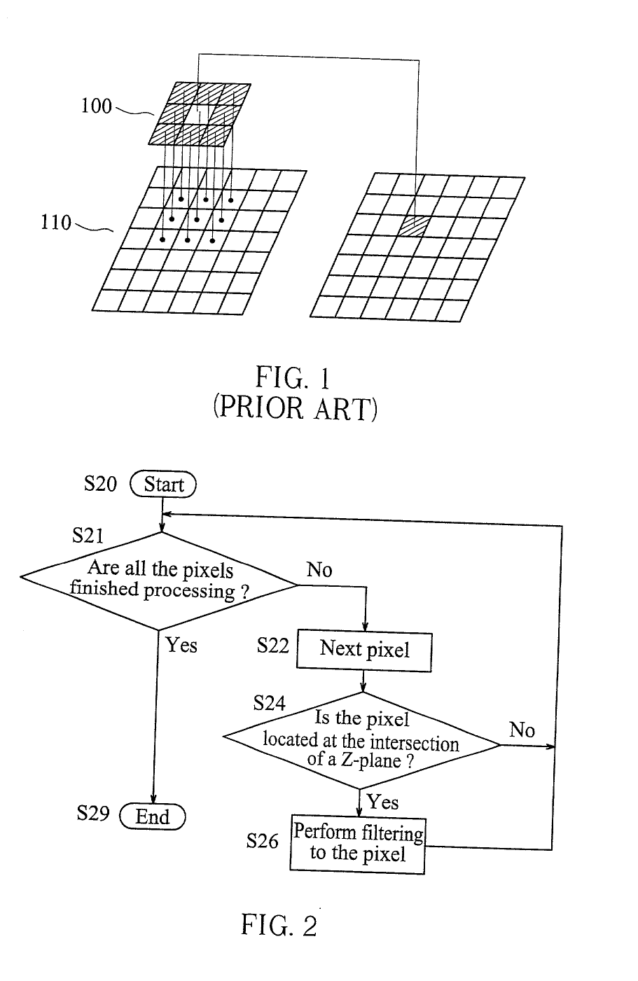

FIG. 2 is the post filtering method for eliminating the jagged effect of the first embodiment according to the invention. The method of the first embodiment makes use of the Z-border test to judge if performing filtering to a pixel is needed. In referring to FIG. 2, the action flow-chart of the post filtering method is described as follows:

Step S20: Start the filtering process;

Step S21: Judging if all the pixels are finished processing, if it is so, jump to step S29, otherwise proceed to Step S22;

Step S22: Read in the next pixel data;

Step S24: Judging if the pixel is located at the intersection of the Z-plane in accordance with the Z-border test, if it is so, jumps to step S26, otherwise proceeds to Step S21;

Step S26: Performing filtering to the pixel by the use of a conventional filtering method (e.g. digital filter), and jumps back to step S21;

Step S29: End the filtering process.

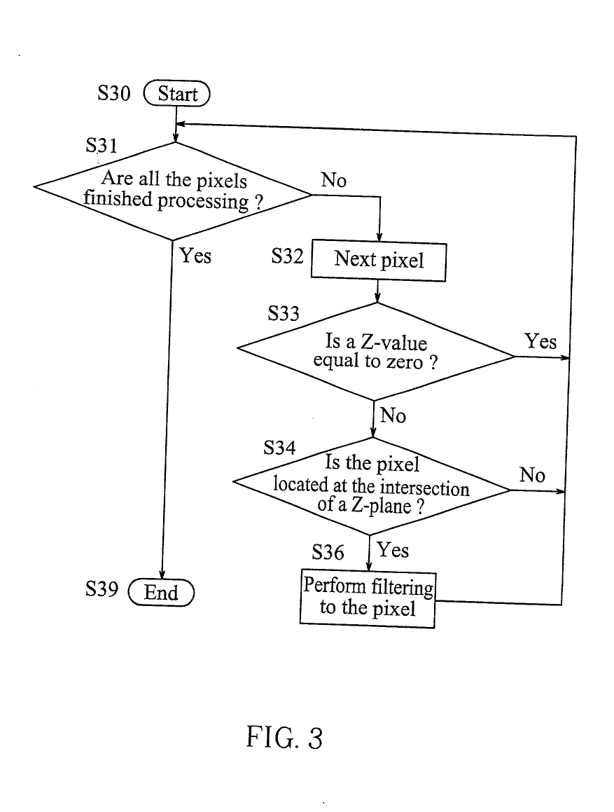

FIG. 3 shows the post filtering method for eliminating the jagged effect of the second embodiment according to the invention. The method of the second embodiment makes use of the Z-border test and the Zero-Z test to judge if performing filtering to a pixel is needed. By doing this, one can perform filtering to the graphic image on the up-most layer and perform filtering to the border of the graphic image on the layers other than the up-most layer. In referring to FIG. 3, the action flow-chart of the post filtering method is described as follows:

Step S30: Start the filtering process;

Step S31: Judging if all the pixels are finished processing, if they are so, jump to step S39, otherwise proceed to Step S32;

Step S32: Read in the next pixel data;

Step S33: Judging if the pixel located at the up-most layer of the graphic image in accordance with the Zero-Z test, if Z=0 which indicates that the pixel located at the up-most layer of the graphic image, then jump to step S31, otherwise proceed to Step S34;

Step S34: Judging if the pixel located at the intersection of the Z-plane in accordance with the Z-border test, if it is so, jump to step S36, otherwise proceed to Step S31

Step S36: Performing filtering to the pixel by the use of the conventional filtering method (e.g. digital filter), and jump back to step S31;

Step S39: End the filtering process.

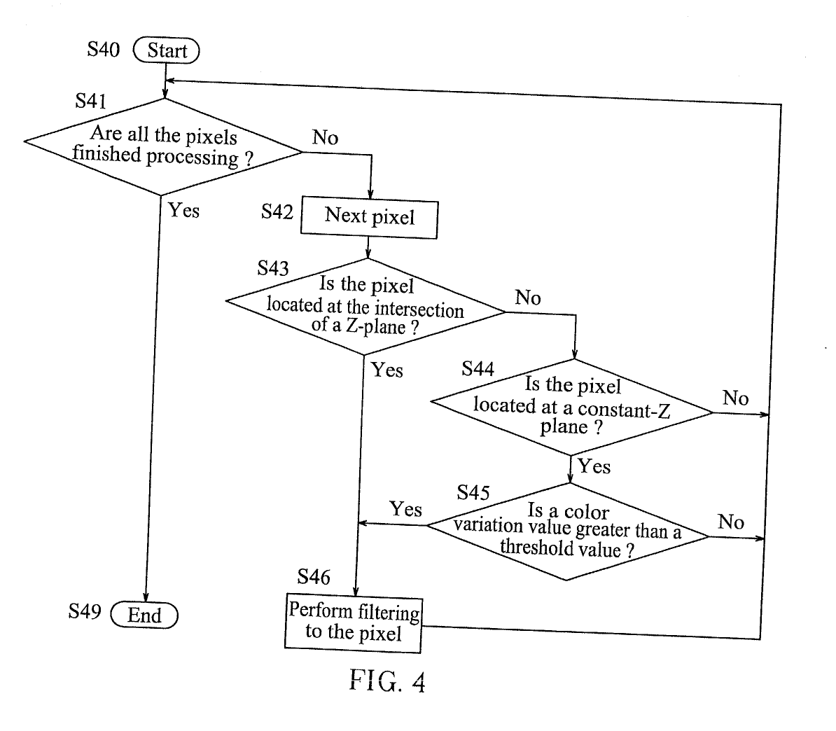

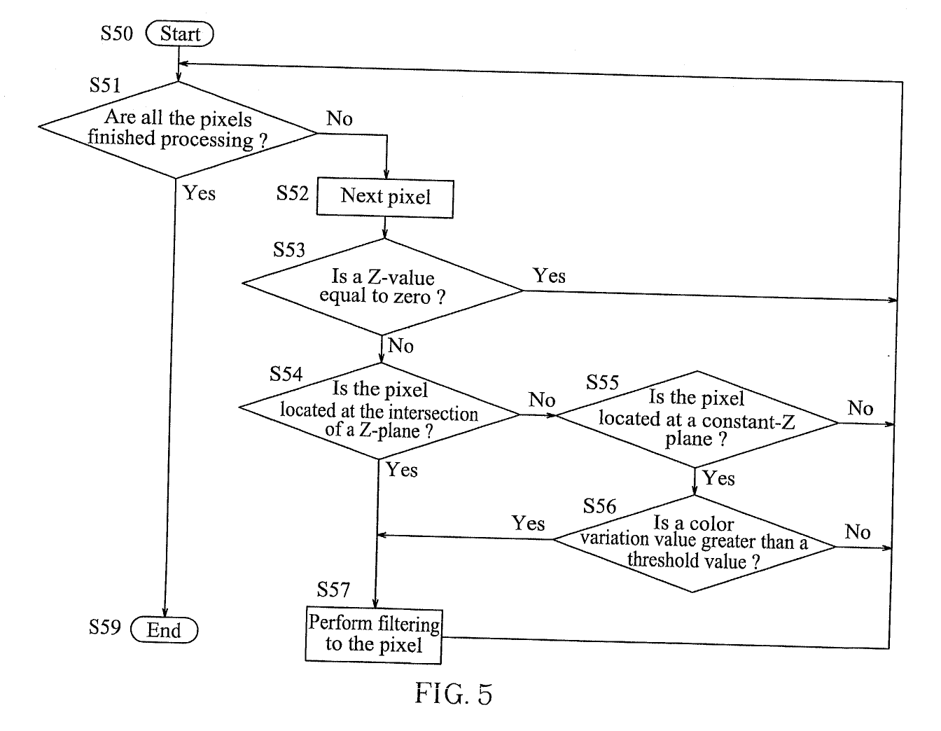

FIG. 4 is the post filtering method for eliminating the jagged effect of the third embodiment according to the invention. The method of the third embodiment makes use of the Z-border test, the Constant-Z test, and the color variation test to judge if performing filtering to a pixel is needed. Therefore, the third embodiment not only can perform filtering to the pixels on the border of objects in the graphic image. In referring to FIG. 4, the action flow-chart of the post filtering method is described as follows:

Step S40: Start the filtering process;

Step S41: Judging if all the pixels are finished processing, if it is so, jump to step S49, otherwise proceed to Step S42;

Step S42: Read in the next pixel data;

Step S43: Judging if the pixel located at the intersection of the Z-plane, if it is so, jump to step S46, otherwise proceed to Step S44;

Step S44: Judging if the pixel located at the constant-Z plane in accordance with the Constant-Z test, if it is so, proceed to step S45, otherwise jump back to Step S41;

Step S45: Judging if the pixel's color variation value greater than the threshold value in accordance with the Color-variation test, if it is so, proceed to step S46, otherwise jump back to Step S41;

Step S46: Performing filtering to the pixel by the use of the conventional filtering method, and jumping back to step S41;

Step S49: End the filtering process.

FIG. 5 is the post filtering method for eliminating the jagged effect of the fourth embodiment according to the invention. The method of the fourth embodiment makes use of the Zero-Z test, the Z-border test, the Constant-Z test, and Color-variation test to judge if performing filtering to a pixel is needed. Therefore, the fourth embodiment can perform filtering to the pixels on the border of the objects in the graphic image as well as to the pixels having excessive color difference on the same Z-plane. In referring to FIG. 5, the action flow-chart of the post filtering method is described as follows:

Step S50: Start the filtering process;

Step S51: Judging if all the pixels are finished processing, if it is so, jump to step S59, otherwise proceed to Step S52;

Step S52: Read in the next pixel data;

Step S53: Judging if the pixel located at the up-most top layer of the image in accordance with the Zero-Z test, if it is so, jump to step S51, otherwise proceed to Step S54;

Step S54: Judging if the pixel located at the intersection of the plane in accordance with the the Z-border test, if it is so, jump to step S57, otherwise proceed to Step S55;

Step S55: Judging if the pixel located at the constant-Z plane in accordance with the Constant-Z test, if it is so, proceed to step S56, otherwise jump back to Step S51;

Step S56: Judging if the pixel's color variation value greater than the threshold value in accordance with the Color-variation test, if it is so, proceed to step S57, otherwise jump back to Step S51;

Step S57: Performing filtering to the pixel by the use of a conventional filtering method (e.g. digital filter), and jumping back to step S51;

Step S59: End the filtering process.

Since the post filtering method for eliminating jagged effects of the invention before outputing the graphic images performs filtering only to those pixels on the border of objects in the graphic image rather than to all the pixels of the graphic image. Therefore, the blurring effect can be avoided, and the perceptual quality of the graphic image can be satisfied.

The invention has been described using an exemplary preferred -embodiment. However, it is to be understood that the scope of the invention is not limited to the disclosed embodiment. On the contrary, it is intended to cover various modifications and similar arrangements. The scope of the claims, therefore, should be accorded the broadest interpretation so as to encompass all such modifications and similar arrangements.

What is claimed is:

1. A post filtering method for eliminating jagged effects before outputing graphic image in accordance with the characteristics of each of a pixel to determine if the pixel needs to perform filtering comprising the following steps:
(a) judging if a Z-value of the pixel's is equal to zero, if it is, then not perform filtering to the pixel; and
(b) if the Z-value of the pixel is not equal to zero, then judging if the pixel is located at the intersection of a Z-plane, if it is, then performs filtering to the pixel.

2. The post filtering method for eliminating jagged effects of claim 1 further comprising the following steps:
(c) if the pixel is not located at the intersection of the Z-plane, then judging if the pixel is located at a constant-Z plane, if it is not, then not perform filtering to the pixel; and
(d) if the pixel is located at the constant-Z plane, then judging if a color variation value of the pixel is greater than a threshold value, if it is, then performs filtering to the pixel.

3. The post filtering method for eliminating jagged effects of claim 1 or claim 2, wherein a device for performing filtering action is a digital filter.

4. A post filtering method for eliminating jagged effects before outputing graphic image in accordance with the characteristics of each of the pixels to determine if a pixel needs to perform filtering comprising the following steps:
(a) judging if a Z-value of the pixel is equal to zero, if it is, then not perform filtering to the pixel;
(b) if the Z-value of the pixel is not equal to zero, then judging if the pixel is located at the intersection of a Z-plane, if it is, then performs filtering to the pixel;
(c) if the pixel is not located at the intersection of the Z-plane, then judging if the pixel is located at a constant-Z plane, if it is not, then not perform filtering to the pixel; and
(d) if the pixel is located at the constant-Z plane, then judging if a color variation value of the pixel is greater than a threshold value, if it is. then performs filtering to the pixel.

5. The post filtering method for eliminating jagged effects of claim 4, wherein a device for performing filtering action is a digital filter.
